(19) United States
(12) Patent Application Publication
(10) Pub. No.: US 2007/0216776 A1
(43) Pub. Date: Sep. 20, 2007

(54) Color image reproduction

(75) Inventor: Geoffrey John Woolfe, Canandaigua, NY (US)

Correspondence Address: PEPPER HAMILTON LLP, ONE MELLON CENTER, 50TH FLOOR, 500 GRANT STREET, PITTSBURGH, PA, 15219, US

(73) Assignee: Xerox Corporation

(21) Appl. No.: 11/374,839

(22) Filed: Mar. 14, 2006

(51) Int. Cl. H04N 5/228

(52) U.S. Cl. 348/222.1; 345/589

(57) ABSTRACT

A method for absolute color image reproduction comprises an image capture device, wherein the image capture device captures scene image data and associated scene viewing environment data. The scene viewing environment data are transformed into color appearance model profile (CAMP) viewing parameters. The scene image data and the CAMP viewing parameters are input into a color management system. The color management system utilizes the scene image data and the CAMP viewing parameters to output from an image output device a color reproduced image.

### BACKGROUND

Color matching or color management is a process intended to allow device-dependent colors to appear the same on different devices. For example, color management may include a computer-controlled color communication between various devices, such as digital cameras, video camcorders, scanners, xerographic devices, monitors, printers, offset presses, and other media. Color management systems attempt to match the color appearance of images or documents on a destination device to an original color appearance on a source or source device. Color management systems provide a means to convert color data between device-dependent encodings and device independent encodings. By utilizing a small number of common device independent encodings as a ‘connection space,’ color management systems can translate color data encoded for one device into a second encoding for another device, maintaining a consistent color appearance across the two devices. The devices that commonly use color management include digital cameras, monitors, printers, and scanners. Each device has its own gamut, or range of colors that the device can create or represent. The gamut represents the boundary of a device-dependent color space. Examples of device dependent color spaces include, but are not limited to: RGB (Red, Green, and Blue), and CMYK (Cyan, Magenta, Yellow and Black). RGB has been typically used for monitors comprising cathode ray tubes. CMYK is a commonly used color space for printers.

Color management systems typically accomplish color matching by relating a device dependent color space to a device independent color space (or absolute color space). A device dependent color space is based on the control parameters used to control or drive the device. For example, three control signals, commonly called R, G, and B are used to control a computer monitor, and hence, device-dependent monitor color spaces are typically called RGB spaces. A device independent color space is one in which the colors are described by reference to the human visual system, and have no reliance on any external factors related to a particular device. Examples of device independent color spaces include, but are not limited to: CIE XYZ (also called the “norm system”) (Commission Internationale de l'Eclairage—International Commission on Illumination), and CIE L*a*b*, which uses three variables that related to human perception of color: a luminance, L* (L-star) and color values on a red-green axis (a*) and a blue-yellow axis (b*). There is another important class of color spaces that are device-dependent and calorimetric. These are color spaces that are based on a hypothetical reference device, and have an unambiguous mathematical relationship to device-independent color spaces such as CIE XYZ. Colorimetric, device-dependent color spaces include, but are not limited to: sRGB (standard Red, Green, Blue), ProPhoto RGB, and Adobe RGB.

Color management systems use device characterization profiles, or mapping functions, to provide the information necessary to convert color data between native device color spaces and device independent color spaces. An example of this is transferring the image from a computer monitor to a printer. When outputting device dependent RGB color from a computer monitor, the (source) device profile is used to convert from device dependent RGB to a device independent color space, such as for example, CIE XYZ. A second (destination) device profile is used to convert the colors from CIE XYZ to the device specific color space of the printer, generally CMYK. If a specified color is not in the gamut of the device, the color is said to be out of gamut. The destination profile will also typically perform a gamut transformation that maps any output of gamut color to an alternative color that is within the gamut of the targeted device.

Colorimetric spaces describe the color matching behavior of human observers. This means that when two color stimuli have equal colorimetric color space values, those stimuli will match in appearance, under identical viewing conditions. Device-independent color spaces are always colorimetric spaces. Such calorimetric color spaces, however, are not able to describe the absolute color appearance of the stimuli without additional information about the viewing environment, and hence, the state of visual adaptation of the observer. Absolute color image reproduction is not possible without the viewing environment information. Therefore, calorimetric color spaces can only be successfully used in color management applications if the viewing environment is fixed for both the source and the destination devices.

Color appearance models have been developed that can describe absolute color appearance based on colorimetric color space data and a set of additional parameters that describe the viewing environment of the stimuli. Important viewing environment parameters in such models include the illuminant chromaticity and the absolute illuminance level of the environment. The contemporary CIECAM02 color appearance space, which has been proposed as a color connection space for the Microsoft Vista™ client developer platform, requires a number of parameters that describe the viewing environment of the image. These parameters are supplied to the color management engine in a file called a Color Appearance Model Profile (CAMP). A significant complication of this system is the difficulty of determining the appropriate viewing parameters, such as white point and absolute illuminance level to put in the CAMP file.

One complication in the use of color appearance models is the difficulty of determining the appropriate viewing environment parameters. U.S. Pat. App. Pub. No. 2002/0196972 discloses a method for a color correction technique that involves sensing an illuminant and performing a color correction based on the sensed illuminant. This is achieved by equipping output devices such as color printers, color monitors, and color digital cameras with dedicated illuminant sensor(s). U.S. Pat. No. 5,546,195 teaches the use of a photometer and a neural network management unit to serve as a reproduced color correction system. Each of these prior art systems requires additional, dedicated equipment. U.S. Pat. No. 6,795,084 teaches a heuristic analysis to infer the color environment of computerized imaging apparatus. This is a probabilistic approach by which a color environment is inferred based on probabilities rather than certainties. Alternatively, some systems simply use default parameters, which may or may not relate to the actual viewing environment.

For devices such as digital cameras, which are intended to capture original scenes, there is no such constant, or well-defined, viewing environment. Digital cameras are used in environments of widely differing absolute illuminance and illuminant chromaticity. Therefore, one cannot simply ascribe a fixed default set of viewing environment parameters to scene images captured by a digital camera. Furthermore, the vast majority of digital camera users lack the required training to manually input the viewing environment parameters for each scene into the CAMP file of the color management application.

### SUMMARY

A method for outputting a color image that includes capturing, via an image capture device having an image sensor, a scene image in an image file, and identifying, via the image sensor, scene viewing environment data. The scene viewing environment data are associated with the image file. Color appearance model profile parameters are calculated from the scene viewing environment data. The image file and the color appearance model profile parameters are input to a color management system, and a color reproduced image is output.

### BRIEF DESCRIPTION OF THE DRAWINGS

FIG. 1 depicts a flow diagram for an exemplary embodiment of a method of reproducing an absolute color image employing an image capture device having a single sensor to capture a scene image and determine associated scene viewing environment data, transform the data into a set of CAMP parameters and tag the image file with either the CAMP parameters or a CAMP file.

FIG. 2 depicts a flow diagram for an exemplary embodiment of a method of reproducing an absolute color image employing an image capture device having an image sensor to capture a scene image and determine associated scene viewing environment data, and tag the data to the scene image file, transform the data into a CAMP, and tag the image with the CAMP.

### DETAILED DESCRIPTION

Before the present methods, systems and materials are described, it is to be understood that this disclosure is not limited to the particular methodologies, systems and materials described, as these may vary. It is also to be understood that the terminology used in the description is for the purpose of describing the particular versions or embodiments only, and is not intended to limit the scope.

It must also be noted that as used herein and in the appended claims, the singular forms “a,” “an,” and “the” include plural references unless the context clearly dictates otherwise. Unless defined otherwise, all technical and scientific terms used herein have the same meanings as commonly understood by one of ordinary skill in the art. Although any methods, materials, and devices similar or equivalent to those described herein can be used in the practice or testing of embodiments, the preferred methods, materials, and devices are now described. All publications mentioned herein are incorporated by reference. Nothing herein is to be construed as an admission that the embodiments described herein are not entitled to antedate such disclosure by virtue of prior invention.

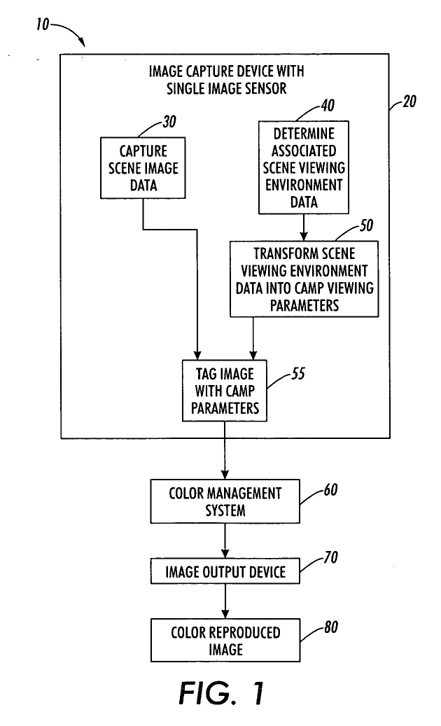

Referring to FIG. 1, an embodiment of a method for absolute color image reproduction 10 comprises an image capture device 20 having a single image sensor, wherein the image capture device 20 captures scene image data 30 and identifies or determines associated scene viewing environment data 40 via the single image sensor. In an embodiment the scene image data 30 may be in a RAW image format. The scene viewing environment data 40 are transformed into Color Appearance Model Profile (CAMP) viewing parameters 50. The CAMP 50 is tagged 55 to the image. The scene image data 30 and the CAMP viewing parameters 50 are input into a color management system 60. The color management system 60 utilizes the scene image data 30 and the CAMP viewing parameters 50 to output from an image output device 70 an absolute color reproduced image 80. In an embodiment, other profile files (not shown) in addition to the scene image data 30 and the CAMP viewing parameters 50 may be required by, and typically are inherent in, the color management system 60. These may include, for example: a device characterization profile and a gamut mapping profile; it is recognized that these files and others are typically known to persons of ordinary skill in the art. It is further recognized that methods of capturing of scene image data are known to those skilled in the art, and may include image input devices, such as, but not limited to: an analog or digital still or video camera, a scanner, a photocopier, or a fax machine.

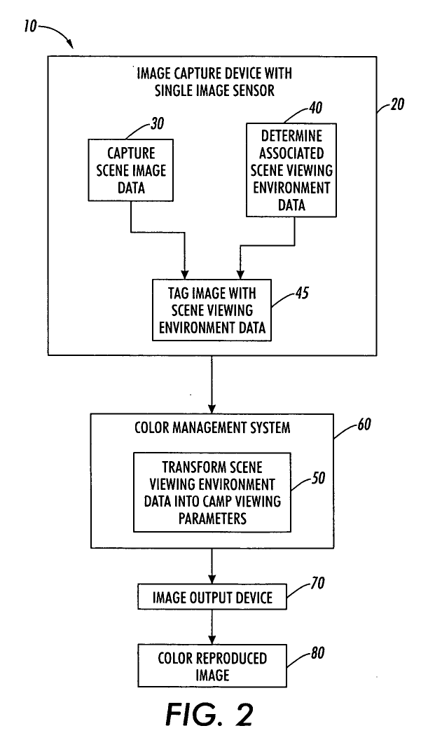

Referring to FIG. 2, an embodiment of a method for absolute color image reproduction 10 comprises an image capture device 20 having a single image sensor, wherein the image capture device 20 captures scene image data 30 and identifies or determines associated scene viewing environment data 40 via the single image sensor. In an embodiment the scene image data 30 may be in a RAW image format. The scene viewing environment data 40 may be in the form of metadata. The scene viewing environment data 40 are tagged 45 to the scene image data 30. In a different embodiment the scene viewing environment data 40 may be embedded into a plurality of pixel values (not shown) comprising the scene image data 30. This process is known to those skilled in the art as steganography. Now referring back to FIG. 2, the scene image data 30 that are tagged 45 or embedded with the scene viewing environment data 40 are input into a color management system 60. The scene viewing environment data 40 are transformed into Color Appearance Model Profile (CAMP) viewing parameters 50. The color management system 60 utilizes the scene image data 30 and the CAMP viewing parameters 50 to output from an image output device 70 an absolute color reproduced image 80. In an embodiment, other profile files (not shown) in addition to the scene image data 30 and the CAMP viewing parameters 50 may be required by, and typically are inherent in, the color management system 60. These may include, for example: a device characterization profile and a gamut mapping profile; it is recognized that these files and others are typically known to persons of ordinary skill in the art. It is further recognized that methods of capturing of scene image data are known to those skilled in the art, and may include image input devices, such as, but not limited to: an analog or digital still or video camera, a scanner, a photocopier, or a fax machine.

An embodiment uses an image capture device, such as, for example, an analog or digital still or video camera, a scanner, a photocopier, a fax machine, or another device to determine the viewing environment parameters of a scene. The parameters may be used in a color appearance model such as sRGB, CIE XYZ, CIE L*a*b*, or CIECAM02. In one embodiment, there are several viewing environment parameters that are captured by the image capture device that are used by the color management system to reproduce true and accurate or absolute colors. These include the adaptive white point, the absolute luminance level, and tristimulus values of the source background.

The adaptive white point, or herein used interchangeably, the illuminant chromaticity or adapting illuminant, is one of the key parameters of any color appearance model, because it is one of the major factors affecting an observers state of visual adaptation. The adaptive white point can be described in a number of ways including its correlated color temperature or the illuminant chromaticity coordinates. These descriptions are well known to those skilled in the art. Adaptive white points can also be described using a categorical label corresponding to the standard illuminant most closely resembling the adapting illuminant. Such categorical labels include, but are not limited to, such specific descriptions as D50, illuminant A, or fluorescent illuminant F2, or may be less specifically described using terms such as daylight, fluorescent, flash, or tungsten. These latter, less specific terms are commonly used on digital cameras or consumer film. The adaptive white point affects the state of chromatic adaptation of the observer, in that the adaptive white point exhibits a chromaticity that appears achromatic, or neutral, to an observer who is adapted to the viewing environment. This parameter can be identified and determined by any digital camera or other image capture device that incorporates a white balance adjustment mechanism. As such, additional equipment is not required to obtain the adaptive white point. This can be illustrated for the case of digital cameras having white balance adjustment capability. In these devices the white balance setting is used to adjust the relative gains of the red, green and blue channels of the sensor in such a way that objects having the same chromaticity as the white balance setting are encoded as having a neutral color appearance in the image. These digital cameras have several methods for setting the white balance. Firstly, there are a number of fixed illuminant settings that the camera operator can choose between. These manual settings generally correspond to broad categorical descriptions of illuminants using terms such as tungsten, fluorescent, daylight, cloudy, shade etc. Each of these categories actually corresponds to a specific white balance setting that can be considered the prototypical representative of that illuminant category. For example, tungsten might refer to the illuminant chromaticity of sixty (60) Watt tungsten light bulbs commonly found in homes. Although the manual settings preclude an exact determination of the actual illuminant in use when the picture was taken, this approach is generally quite good enough to render pleasing images in most cases. Another method of white balance determination can be used in the case of flash photography. In such cases the camera can automatically determine if the flash fired. In consumer cameras, the illuminant chromaticity of the built in flash is accurately known, and can be used to set the correct white balance. In the case of external flash units, it is usually sufficient to use a typical average value of illuminant chromaticity. A third method of white balance adjustment allows the camera operator to direct the camera towards a known neutral object and the camera can automatically adjust the red, green and blue gains in the sensor until the object is recorded as neutral. This procedure allows the camera to compute the approximate chromaticity of the illuminant. Yet another method used to determine white balance in cameras is commonly called automatic white balance. This automatic setting comprises an algorithm that analyses image sensor data for the scene for automatic white balance determination. In the latter case there may be algorithms on varying levels of sophistication, ranging from simple gray-world assumptions to techniques involving image content analysis. Regardless of the algorithm used, or even if the white balance is set manually by the camera operator, it is sufficient that the device is capable of reporting at least an estimate of the illuminant chromaticity that can be tagged onto or associated with the image. The estimate might take the form of CIE XYZ tristimulus values, illuminant chromaticity coordinates, a correlated color temperature, or any other suitable metric from which illuminant chromaticity can be derived.

Another parameter that is used in color appearance models is the absolute illuminance level of the environment, or the intensity of the light falling on the objects in the scene. This parameter has an effect on the perception of both colorfulness and luminance contrast. Cameras, for example, do not intrinsically determine the absolute illuminance level of the scene. However, any camera having an automated metering or exposure system adjusts camera settings in response to the absolute scene luminance, or the light reflected from objects in the scene. Scene illuminance, E, and scene luminance, L, are directly related, by Equation 1:
E=(Lπ)/β, {Equation 1}

where E, the scene illuminance is in the units of lux (lumens per square meter); L, the scene luminance is in the units of candelas per square meter; the constant π assumes its standard value of approximately 3.14159; and β is the reflectance factor of the objects in the scene. While the parameter β has an estimated canonical average value of about 0.18 for scenes in general, it is also possible to develop a more refined estimate of the value of β by analysis of the scene content. It is recognized by those skilled in the art that other units of measurement can be used in Equation 1, with appropriate adjustments of the value of β. The estimation of β and Equation 1 are further discussed infra.

It is well recognized that under conditions of high ambient scene illumination levels, and hence high scene luminance levels, the automated camera exposure system will set combinations of smaller apertures and higher shutter speeds compared to the settings in more dimly lit environments. For example images taken under sunny conditions outdoors might require a shutter speed of 1/250 second and a lens aperture of f/16. The same scenes captured on a dull overcast day, with a much lower level of ambient illumination, might require a much slower shutter speed of 1/60 second and a wider aperture such as f/8. (Note: Apertures are frequently described using f numbers where the f number represents a ratio of focal length to lens opening. Accordingly, smaller f numbers correspond to wider lens openings or apertures. Thus aperture size and shutter speed camera settings can be used to determine the scene illuminance level. In addition to shutter speed and aperture, one also needs to know the International Organization for Standardization (ISO) speed setting of the camera and any exposure compensation setting that is in effect to make the determination. Equation 2 is an example of the relationship of these factors to luminance, L, and is well known to those skilled in the art:
L=(12.4×(aperture²))/(exposureTime×ISOFilmSpeed×2^{-exposureCompensation}) {Equation 2}

where L has the units of candelas per square meter. Exposure time in Equation 2 is measured in seconds, and exposure compensation is measured in stops (+1 meaning one stop overexposure). The constant 12.4 represents an average value, but the ISO photographic speed standard states that the constant should be in the range of 10.6 to 13.4. It is recognized by those skilled in the art that other units of measurement can be used in Equation 2, with appropriate adjustments of the value of the constant. Furthermore, alternatives to equation 2 could be used to determine scene luminance. Such alternatives may be needed to account for specific design peculiarities of certain cameras or sensors. However, the exact form of the relationship between camera exposure settings and scene luminance is not the issue. It is sufficient that for any given image capture device with an exposure adjustment system the relationship between scene luminance and exposure settings can be determined, the scene illuminance can be determined from the scene luminance and this scene illuminance can be associated with or tagged onto the image for use in a color appearance model.

As indicated supra, cameras respond to the light reflected from objects in the scene (scene luminance), but the color appearance model requires the intensity of the light falling on the objects in the scene (scene illuminance). Equation 1, supra, defines this relationship, and involves an estimation for β, the reflectance factor of the objects in the scene. However, the small error involved in such estimation is relatively unimportant for color appearance modeling. The relationship between illuminance, E, and luminance, L, depends on the reflectance factor of the objects in the scene, β. Since all objects have different reflectance factors, the simple assumption is often made that the average reflectance of a collection of objects in a typical scene is 0.18, that is β=0.18. This is commonly called the gray-world approximation, and simply means that the world reflectance averages out to an 18% reflecting gray card. More sophisticated methods to estimate β are possible if image content analysis is performed, but this is unlikely to be necessary for the purpose of color appearance modeling.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method, comprising:
capturing, via an image capture device having an image sensor, a scene image in an image file;
identifying, via the image sensor, scene viewing environment data, wherein the scene viewing environment data are associated with the image file; and
calculating color appearance model profile parameters from the scene viewing environment data;
inputting the image file and the color appearance model profile parameters to a color management system; and
outputting a color reproduced image.

2. The method of claim 1, wherein the image capture device is a camera.

3. The method of claim 2, wherein the scene viewing environment data are determined using values of image capture device settings comprising aperture, exposure time, ISO film speed, exposure compensation. and white balance adjustment setting.

4. The method of claim 1, wherein the scene viewing environment data comprise metadata tagged to the image file.

5. The method of claim 1, wherein the scene image comprises a plurality of pixel values, and the scene viewing environment data are encoded in the plurality of pixel values.

6. The method of claim 1, wherein the color appearance model profile parameters comprise adaptive white point.

7. The method of claim 1, wherein the color appearance model profile parameters comprise absolute illuminance.

8. The method of claim 1, wherein the color appearance model profile parameters comprise illuminant chromaticity.

9. The method of claim 1, wherein the image capture device comprises a video camera.

10. The method of claim 1, wherein the image capture device comprises a xerographic device.

11. The method of claim 1, wherein the color management system utilizes a color appearance space.

12. The method of claim 11, wherein the color appearance space comprises CIECAM02.

13. A method for reproducing a color image, comprising:
capturing, via a digital camera having an image sensor, a scene image in an image file;
identifying, via the image sensor, scene viewing environment data, wherein the scene viewing environment data comprise metadata tagged to the image file;
calculating, via the digital camera, color appearance model profile parameters from the scene viewing environment data;
inputting the image file and the color appearance model profile parameters to a color management system; and
outputting a color reproduced image.

14. The method of claim 13, wherein the scene viewing environment data are determined using values of the digital camera settings comprising: aperture, exposure time, ISO film speed, exposure compensation. and white balance adjustment setting.

15. The method of claim 13, wherein the color appearance model profile parameters comprise adaptive white point.

16. The method of claim 13, wherein the color appearance model profile parameters comprise absolute illuminance.

17. The method of claim 13, wherein the color appearance model profile parameters comprise illuminant chromaticity.

18. The method of claim 13, wherein the color management system comprises a color appearance space.

19. The method of claim 18, wherein the color appearance space comprises CIECAM02.

20. A method for reproducing an absolute color image, comprising:
capturing, via a digital camera having an image sensor, a scene image in an image file;
identifying, via the image sensor, scene viewing environment data, wherein the scene viewing environment data comprise metadata tagged to the image file, wherein the metadata are determined using values of the digital camera settings comprising: aperture, exposure time, ISO film speed, exposure compensation, and white balance adjustment;
calculating, via the digital camera, color appearance model profile parameters from the scene viewing environment data, wherein the color appearance model profile parameters comprise: adaptive white point, absolute illuminance, and illuminant chromaticity;
inputting the image file and the color appearance model profile parameters to a color management system; and
outputting a color reproduced image.
